(19) United States
(12) Patent Application Publication
(10) Pub. No.: US 2026/0143256 A1
(43) Pub. Date: May 21, 2026

(54) IMAGE PROCESSING DEVICE

(71) Applicant: SK hynix Inc., Gyeonggi-do (KR)

(72) Inventors: Cheol Jon JANG, Gyeonggi-do (KR); Jong Joo PARK, Gyeonggi-do (KR)

(21) Appl. No.: 19/388,892

(22) Filed: Nov. 13, 2025

(30) Foreign Application Priority Data
Nov. 19, 2024 (KR) 10-2024-0165089

(51) Int. Cl. H04N 25/68

(52) U.S. Cl. CPC H04N 25/68

(57) ABSTRACT

An image processing device includes a target pixel defect determiner configured to determine whether a target pixel within a kernel is a defective pixel; a cluster defective pixel detector configured to detect at least one cluster defective pixel that serves as the defective pixel sharing a floating diffusion node with the target pixel, when the target pixel is determined to be the defective pixel; an offset correction determiner configured to determine whether to correct the target pixel and the at least one cluster defective pixel based on an offset value of the target pixel; and a defective pixel corrector configured to correct the target pixel and the at least one cluster defective pixel based on a determination to correct the target pixel and the at least one cluster defective pixel.

### CROSS-REFERENCE TO RELATED APPLICATIONS

This patent document claims the priority and benefits of Korean patent application No. 10-2024-0165089, filed on Nov. 19, 2024, the disclosure of which is incorporated herein by reference in its entirety as part of the disclosure of this patent document.

### TECHNICAL FIELD

The technology and implementations disclosed in this patent document generally relate to an image processing device.

### BACKGROUND

An image sensing device is a device for capturing optical images by converting light into electrical signals using a photosensitive semiconductor material which reacts to light. With the development of automotive, medical, computer, and communication industries, the demand for high-performance image sensing devices is increasing in various fields such as smartphones, digital cameras, game machines, Internet of Things (IoT), robots, security cameras and medical micro cameras.

An original image captured by the image sensing device may include an abnormal image caused by defective pixels. Since the image due to such defective pixels causes the quality of the image to deteriorate, a process for correcting the image affected by the defective pixels may be required.

### SUMMARY

Various embodiments of the present disclosure relate to an image processing device capable of correcting pixel values of cluster defective pixels.

Various embodiments of the present disclosure relate to an image processing device capable of detecting cluster defective pixels using a memory in which coordinates of defective pixels are stored.

Various embodiments of the present disclosure relate to an image processing device capable of correcting pixel values of defective pixels using offset values for the defective pixels.

In accordance with an embodiment of the present disclosure, an image processing device may include: a target pixel defect determiner configured to determine whether a target pixel within a kernel is a defective pixel; a cluster defective pixel detector configured to detect at least one cluster defective pixel that serves as the defective pixel sharing a floating diffusion node with the target pixel, based on a determination that the target pixel is the defective pixel; an offset correction determiner configured to determine whether to correct the target pixel and the at least one cluster defective pixel based on an offset value of the target pixel; and a defective pixel corrector configured to correct the target pixel and the at least one cluster defective pixel based on a determination to correct the target pixel and the at least one cluster defective pixel.

In some implementations, the offset correction determiner may be configured to determine whether to correct the target pixel and the at least one cluster defective pixel when a number of the at least one cluster defective pixel is greater than or equal to a threshold value.

In some implementations, the offset value may be determined based on a target pixel value of the target pixel and first homogeneous pixel values of first homogeneous pixels having a same color as the target pixel within the kernel.

In some implementations, the offset value may be a difference between an average value of the first homogeneous pixel values and the target pixel value, under a dark condition in which the target pixel value is less than a first threshold pixel value or under a white condition in which the target pixel value is greater than a second threshold pixel value.

In some implementations, the offset value may be a difference between a median value of the first homogeneous pixel values and the target pixel value, under a dark condition in which the target pixel value is less than a first threshold pixel value or under a white condition in which the target pixel value is greater than a second threshold pixel value.

In some implementations, the offset correction determiner may be configured to determine that the target pixel and the at least one cluster defective pixel are to be corrected based on the offset value, when a target pixel value of the target pixel is greater than a third threshold pixel value and less than a fourth threshold pixel value, and the offset value is greater than a first threshold offset value and less than a second threshold offset value.

In some implementations, the defective pixel corrector may be configured to: in response to determining that the target pixel and the at least one cluster defective pixel are to be corrected based on the offset value, correct a target pixel value of the target pixel and a cluster defective pixel value of the at least one cluster defective pixel based on a value that is obtained by subtracting a correction value calculated using both the offset value and parameter values for the offset value from a target pixel value of the target pixel.

In some implementations, the defective pixel corrector may be configured to determine the parameter values based on a correlation among first homogeneous pixel values of first homogeneous pixels having a same color as the target pixel within the kernel, the target pixel value of the target pixel, second homogeneous pixel values of second homogeneous pixels having a same color as the at least one cluster defective pixel, and cluster defective pixel values of the at least one cluster defective pixel.

In some implementations, the offset correction determiner may be configured to: when it is not determined that the target pixel and the at least one cluster defective pixel are to be corrected based on the offset value, correct the target pixel and the at least one cluster defective pixel based on an average value or a median value of first homogeneous pixel values of first homogeneous pixels having a same color as the target pixel within the kernel.

In some implementations, the cluster defective pixel detector may be configured to detect the at least one cluster defective pixel based on coordinates of the defective pixel stored in an external memory.

In some implementations, the external memory may be a one-time programmable (OTP) memory.

In accordance with another embodiment of the present disclosure, an image processing device may include: a target pixel defect determiner configured to determine whether a target pixel within a kernel is a defective pixel; a cluster defective pixel detector configured to detect a cluster defective pixel that serves as the defective pixel sharing a floating diffusion node with the target pixel, based on a determination that the target pixel is the defective pixel; an offset correction determiner configured to determine whether to correct the target pixel based on a first offset value of the target pixel and to correct the cluster defective pixel based on a second offset value of the cluster defective pixel; and a defective pixel corrector configured to correct the target pixel and the cluster defective pixel based on a determination to correct the target pixel and the cluster defective pixel.

In some implementations, the first offset value may be determined based on a target pixel value of the target pixel and first homogeneous pixel values of first homogeneous pixels having a same color as the target pixel within the kernel; and the second offset value may be determined based on a cluster defective pixel value of the cluster defective pixel and second homogeneous pixel values of second homogeneous pixels having a same color as the cluster defective pixel within the kernel.

In some implementations, the first offset value may be a difference between an average value of the first homogeneous pixel values and the target pixel value under a first dark condition in which the target pixel value is less than a first threshold pixel value, or under a first white condition in which the target pixel value is greater than a second threshold pixel value; and the second offset value may be a difference between an average value of the second homogeneous pixel values and the cluster defective pixel value under a second dark condition in which the cluster defective pixel value is less than the first threshold pixel value, or under a second white condition in which the cluster defective pixel value is greater than the second threshold pixel value.

In some implementations, the first offset value may be a difference between a median value of the first homogeneous pixel values and the target pixel value under a first dark condition in which the target pixel value is less than a first threshold pixel value, or under a first white condition in which the target pixel value is greater than a second threshold pixel value; and the second offset value may be a difference between a median value of the second homogeneous pixel values and the cluster defective pixel value under a second dark condition in which the cluster defective pixel value is less than the first threshold pixel value, or under a second white condition in which the cluster defective pixel value is greater than the second threshold pixel value.

In some implementations, the offset correction determiner may be configured to: in response to determining that a target pixel value of the target pixel and a cluster defective pixel value of the cluster defective pixel are greater than a third threshold pixel value and less than a fourth threshold pixel value, and the first offset value and the second offset value are greater than a first threshold offset value and less than a second threshold offset value, determine that the target pixel is to be corrected based on the first offset value and the cluster defective pixel is to be corrected based on the second offset value.

In some implementations, the defective pixel corrector may be configured to: in response to determining that the target pixel is to be corrected based on the first offset value, and the cluster defective pixel is to be corrected based on the second offset value, correct the target pixel value using a first value obtained by subtracting a first correction value calculated using the first offset value and parameter values from a target pixel value of the target pixel; and correct the cluster defective pixel value using a second value obtained by subtracting a second correction value calculated using the second offset value and the parameter values from a cluster defective pixel value of the cluster defective pixel.

In some implementations, the defective pixel corrector may be configured to: determine the parameter values based on a correlation among first homogeneous pixel values of first homogeneous pixels having a same color as the target pixel within the kernel, second homogeneous pixel values of second homogeneous pixels having a same color as the cluster defective pixel, the target pixel value of the target pixel, and the cluster defective pixel value of the cluster defective pixel.

In some implementations, the cluster defective pixel detector may be configured to detect the cluster defective pixel based on coordinates of the defective pixel stored in an external memory.

In accordance with another embodiment of the present disclosure, an image processing device may include: a target pixel defect determiner configured to determine whether a target pixel within a kernel is a defective pixel; a cluster defective pixel detector configured to determine whether at least some of cluster pixels sharing a floating diffusion node with the target pixel are defective pixels; an offset correction determiner configured to determine whether to correct the target pixel and cluster defective pixels corresponding to the defective pixel among the cluster pixels based on offset values for the target pixel and the cluster defective pixels; and a defective pixel corrector configured to correct the target pixel and the cluster defective pixels based on a determination to correct the target pixel and the cluster defective pixels.

It is to be understood that both the foregoing general description and the following detailed description of the present disclosure are illustrative and explanatory and are intended to provide further explanation of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of an imaging device according to embodiments of the present disclosure.

FIGS. 2A to 2F are diagrams illustrating an example of cluster defective pixels according to embodiments of the present disclosure.

FIG. 3 is a flowchart illustrating an example of an image processing method according to embodiments of the present disclosure.

FIG. 4 is a flowchart illustrating an example of an image processing method according to embodiments of the present disclosure.

FIG. 5 is a flowchart illustrating an example of an image processing method according to embodiments of the present disclosure.

FIG. 6 is a flowchart illustrating an example of an image processing method according to embodiments of the present disclosure.

FIG. 7 is a schematic diagram illustrating an example of an image processing method according to embodiments of the present disclosure.

FIGS. 8A and 8B are schematic diagrams illustrating an example of an image processing method according to embodiments of the present disclosure.

FIG. 9 is a block diagram illustrating an example of a computing device corresponding to the image processing device of FIG. 1 according to embodiments of the present disclosure.

### DETAILED DESCRIPTION

The present disclosure provides implementations and examples of an image processing device that may be used in configurations to substantially address one or more technical or engineering issues and to mitigate limitations or disadvantages encountered in some other image processing devices. Some implementations of the present disclosure relate to an image processing device that corrects pixel values of cluster defective pixels. Some implementations of the present disclosure relate to an image processing device that detects cluster defective pixels using a memory in which coordinates of defective pixels are stored. Some implementations of the present disclosure relate to an image processing device that corrects pixel values of defective pixels using offset values for the defective pixels. In recognition of the issues above, the present disclosure may provide an image processing device that corrects pixel values of cluster defective pixels without erroneous correction. The present disclosure may provide an image processing device that detects cluster defective pixels using a memory in which coordinates of defective pixels are stored. The present disclosure may provide an image processing device that corrects pixel values of defective pixels without erroneous correction using offset values for the defective pixels.

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein.

In the following description of embodiments of the present disclosure, a detailed description of known functions and configurations incorporated herein will be omitted when it may make the subject matter of the present disclosure rather unclear. In the drawings, parts that are not related to a description of the present disclosure are omitted to clearly explain the present disclosure and similar reference numbers will be used throughout this specification to refer to similar parts.

In the present disclosure, when a component is referred to as being “connected”, “coupled”, or “joined” to another component, it may include not only a direct connection relationship but also an indirect connection relationship in which another component is present therebetween. In addition, when a component “comprises”, “includes” or “has” another component, this means that the component does not exclude other components unless specifically stated above but may further include other components.

In the present disclosure, terms such as “first”, “second”, etc. are used only to distinguish one element from other elements and is not used to limit elements, and unless otherwise specified, it does not limit an order or importance, etc., of elements. Accordingly, within a scope of the present disclosure, a first element in an embodiment may be referred to as a second element in another embodiment and likewise, a second element in an embodiment may be referred to as a first element in another embodiment.

In the following description, components are discriminated from each other to clearly describe their characteristics, but this does not mean that they are necessarily physically separated. That is, a plurality of components may be integrated into one hardware or software module and one component may be divided into a plurality of hardware or software modules. Accordingly, integrated or divided embodiments are within the scope of the present disclosure even if not specifically stated.

In the following description, components described with reference to various embodiments are not all necessarily required and some components may be selectively used. Accordingly, embodiments composed of some of the components described in one embodiment are also within the scope of the present disclosure. Further, embodiments implemented by adding components to various embodiments are also within the scope of the present disclosure.

In the present disclosure expressions of positional relationships used in the present specification such as “top”, “upper”, “bottom”, “lower”, “left”, “right”, etc., are employed for the convenience of explanation, and when the drawings illustrated in the present specification are viewed in reverse, the positional relationships described in the specification may be interpreted in the opposite way.

In the present disclosure, each of phrases such as “A or B”, “at least one of A and B”, “at least one of A or B”, “A, B or C”, “at least one of A, B and C”, “and “at least one of A, B, or C” may include any one or all possible combinations of the items listed together in the corresponding one of the phrases. In description of the present disclosure, the term “and/or” may include a combination of a plurality of items or any one of a plurality of listed items. For example, “A or B” may include “only A”, “only B”, or “both A and B”.

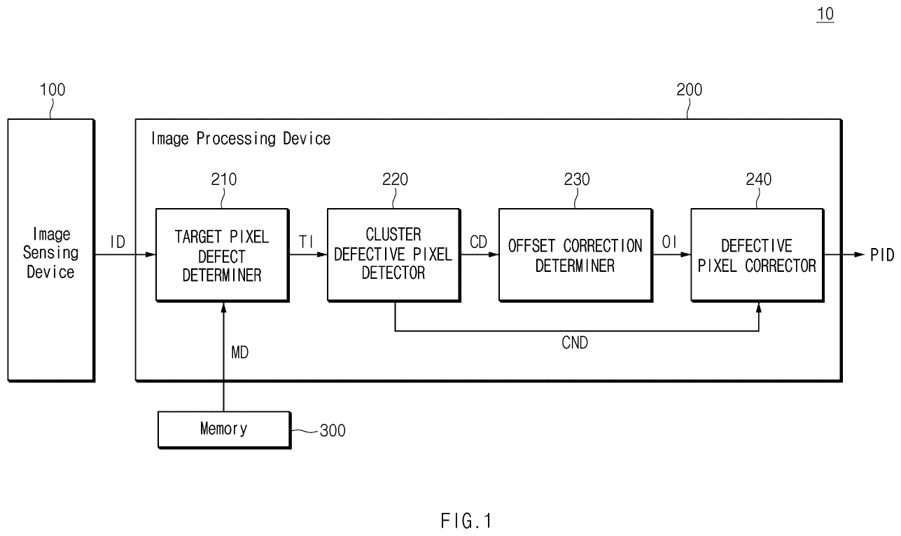

Hereinafter, embodiments of the present disclosure will be described in detail with reference to FIGS. 1 to 9.

FIG. 1 is a block diagram illustrating an example of an imaging device 10 according to embodiments of the present disclosure.

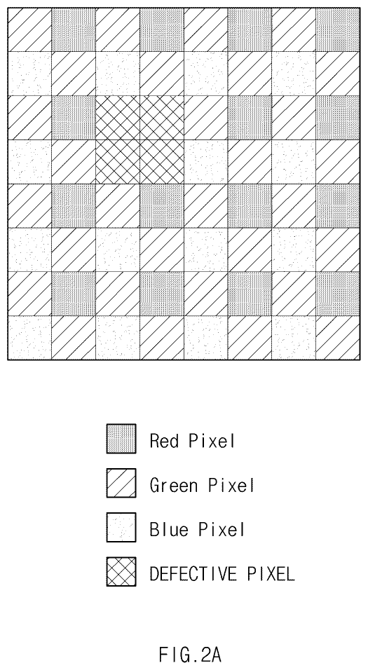

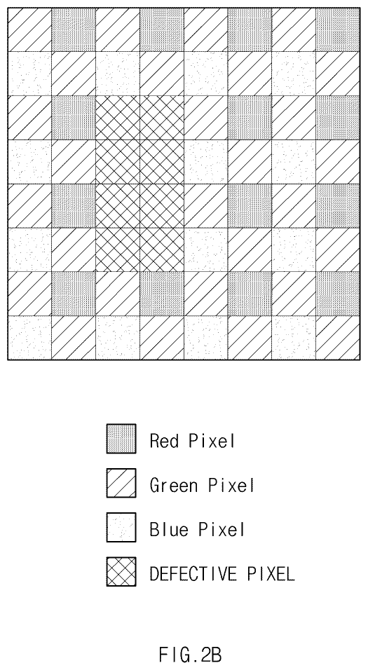

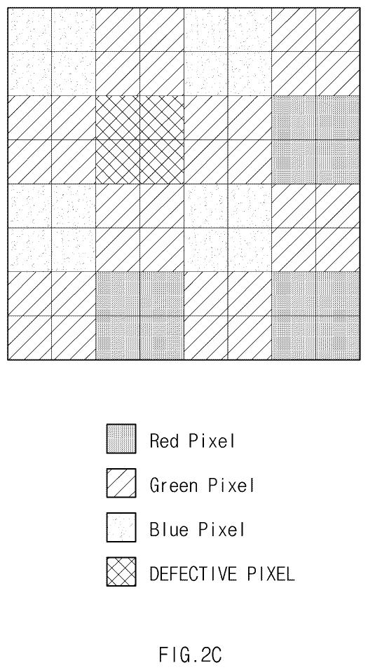

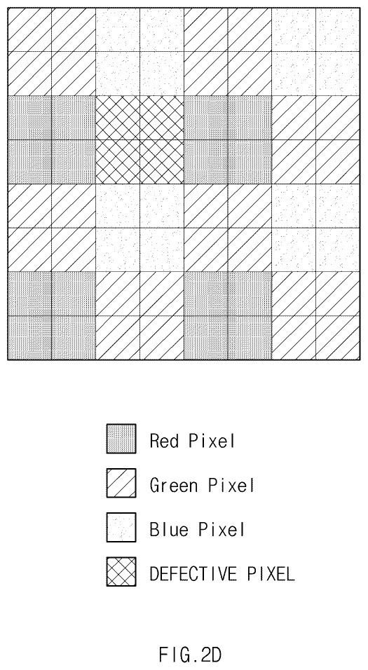

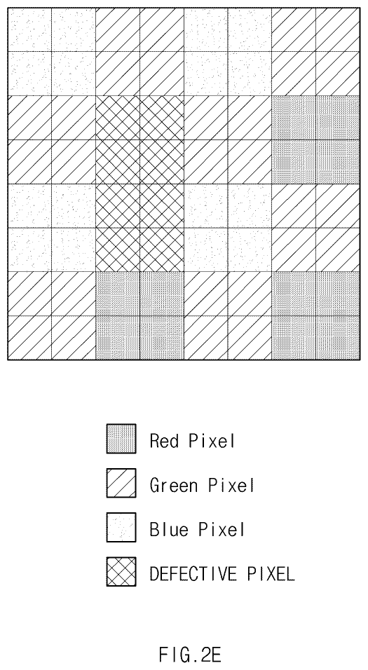

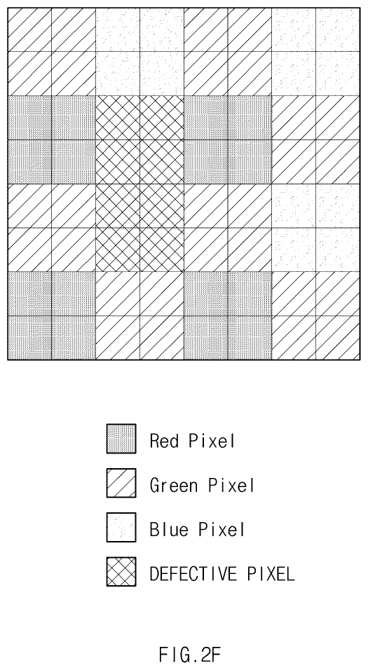

FIGS. 2A to 2F are diagrams illustrating an example of cluster defective pixels according to embodiments of the present disclosure.

Hereinafter, the imaging device 10 of FIG. 1 according to embodiments of the present disclosure will be described with reference to FIGS. 1 and 2A to 2F.

Referring to FIG. 1, the imaging device 10 may refer to a device, for example, a digital still camera for photographing still images or a digital video camera for photographing moving images. For example, the imaging device 10 may be implemented as a Digital Single Lens Reflex (DSLR) camera, a mirrorless camera, or a smartphone, and others. The imaging device 10 may include a device having both a lens and an image pickup element such that the device can capture (or photograph) a target object and can thus create an image of the target object.

The imaging device 10 may include an image sensing device 100, an image processing device 200, and a memory 300.

The image sensing device 100 may be a complementary metal oxide semiconductor image sensor (CIS) for converting an incident light into an electrical signal. Although not shown in FIG. 1, the image sensing device 100 may include a lens module, a pixel array, a sensor driver, a readout circuit, a timing controller, etc. The components of the image sensing device 100 illustrated in FIG. 1 are discussed by way of example only, and the present disclosure encompasses numerous other changes, substitutions, variations, alterations, and modifications.

The image sensing device 100 may generate image data (ID) corresponding to a captured image. The image data (ID) may be digital data obtained by analog-to-digital conversion of analog pixel signals.

The image processing device 200 may perform at least one image signal process on image data (ID) to generate the processed image data.

For example, the image processing device 200 may reduce noise of image data (ID), and may perform various kinds of image signal processing (e.g., demosaicing, defective pixel correction, gamma correction, color filter array interpolation, color matrix, color correction, color enhancement, lens distortion correction, etc.) for image-quality improvement of the image data. In addition, the image processing device 200 may compress image data that has been created by execution of image signal processing for image-quality improvement, such that the image processing device 100 can create an image file using the compressed image data. Alternatively, the image processing device 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image processing device 200 may be a computing device that is mounted on a chip that is independent from the chip on which the image sensing device 100 is mounted, but is not limited thereto. The chip provided with the image sensing device 100 and the chip provided with the image processing device 200 may communicate with each other through a predetermined interface. According to one embodiment, the chip on which the image sensing device 100 is mounted and the chip on which the image processing device 200 is mounted may be implemented in one package, for example, a multi-chip package (MCP), but the scope of the present disclosure is not limited thereto.

The image processing device 200 may include a target pixel defect determiner 210, a cluster defective pixel detector 220, an offset correction determiner 230, and a defective pixel corrector 240.

The target pixel defect determiner 210 may determine whether a target pixel within a kernel is a defective pixel. Specifically, the target pixel defect determiner 210 may receive memory data (MD) from the memory 300. The memory data (MD) may include information about coordinates of defective pixels and offset values of the defective pixels. Accordingly, the target pixel defect determiner 210 may determine whether the coordinates of the target pixel serving as a center pixel of the current kernel are identical to the coordinates of a defective pixel. When the coordinates of the defective pixel are identical to the coordinates of the target pixel, the target pixel defect determiner 210 may determine the target pixel to be a defective pixel. However, the method of determining whether the target pixel is a defective pixel is not limited thereto, and various methods may also be used as necessary.

The cluster defective pixel detector 220 may detect at least one cluster defective pixel included in a kernel. The kernel may include pixels that share a floating diffusion node with the target pixel, and the pixels sharing the floating diffusion node may be referred to as cluster pixels. Among the cluster pixels that share the floating diffusion node with the target pixel, some cluster pixels corresponding to defective pixels may be referred to as cluster defective pixels. The cluster defective pixel detector 220 may receive target pixel information (TI) from the target pixel defect determiner 210. If the target pixel is determined to be a defective pixel, the cluster defective pixel detector 220 may detect at least one cluster defective pixel. For example, the cluster defective pixel detector 220 may compare coordinates of defective pixels with coordinates of cluster pixels, and may detect a cluster defective pixel corresponding to a defective pixel among the cluster pixels. The pixels including the target pixel and the cluster defective pixels may be referred to as a defective pixel cluster.

Referring to FIGS. 2A to 2F, assuming that the size of the kernel is (8×8), the kernel may include various types of defective pixel clusters. For example, FIG. 2A illustrates a (2×2) defective pixel cluster corresponding to a Bayer color filter array (CFA) pattern. FIG. 2B illustrates a (2×4) defective pixel cluster corresponding to two Bayer CFA patterns. FIG. 2C illustrates a (2×2) defective pixel cluster corresponding to red pixels arranged in a quad Bayer CFA pattern. FIG. 2D illustrates a (2×2) defective pixel cluster corresponding to green pixels arranged in a quad Bayer CFA pattern. FIG. 2E illustrates a (2×4) defective pixel cluster corresponding to both red pixels and green pixels arranged in a quad Bayer CFA pattern. FIG. 2F illustrates a (2×4) defective pixel cluster corresponding to both green pixels and blue pixels arranged in a quad Bayer CFA pattern. The defective pixel clusters shown in FIGS. 2A to 2F are merely examples for convenience of description, and a kernel size, the number of cluster defective pixels, and the types of defective pixel clusters according to embodiments of the present disclosure are not limited thereto, and other implementations are also possible.

Referring back to FIG. 1, the cluster defective pixel detector 220 may transmit information (CD) about whether a cluster defective pixel has been detected to the offset correction determiner 230 or the defective pixel corrector 240. For example, when a cluster defective pixel is detected, the cluster defective pixel detector 220 may transmit information (CD) indicating that a cluster defective pixel has been detected to the offset correction determiner 230. In addition, when a cluster defective pixel is not detected, the cluster defective pixel detector 220 may transmit information (CND) indicating that no cluster defective pixel has been detected to the defective pixel corrector 240.

When the number of detected cluster defective pixels is equal to or greater than a threshold value, the cluster defective pixel detector 220 may transmit information (CD) indicating such detection of the cluster defective pixels to the offset correction determiner 230. Furthermore, when the number of detected cluster defective pixels is less than the threshold value, the cluster defective pixel detector 220 may transmit, to the defective pixel corrector 240, information (CND) indicating that a sufficient number of cluster defective pixels have not been detected within the kernel.

The offset correction determiner 230 may determine whether to correct the target pixel and at least one cluster defective pixel based on an offset value. For example, when the number of cluster defective pixels included in the kernel is equal to or greater than a threshold value, the offset correction determiner 230 may determine whether to correct the target pixel and at least one cluster defective pixel based on the offset value. Here, the offset value may represent a difference between the defective pixel and peripheral pixels adjacent to the defective pixel. For example, the offset value may be a value determined by the pixel value of the defective pixel and the pixel values of peripheral pixels of the defective pixel. Here, the peripheral pixels may refer to homogeneous pixels having the same color as the defective pixel. The offset value may be a value determined by the pixel value of the defective pixel and the pixel values of the peripheral pixels under conditions darker than a predetermined brightness (luminance). Alternatively, the offset value may be a value determined by the pixel value of the defective pixel and the pixel values of the peripheral pixels under conditions brighter than a predetermined brightness. For example, under a dark condition in which the pixel value of the defective pixel is less than a first threshold pixel value, the offset value may be a difference between an average value of pixel values of homogeneous pixels of the defective pixel and a pixel value of the defective pixel. Alternatively, under a white condition in which the pixel value of the defective pixel is greater than a second threshold pixel value, the offset value may be a difference between the average value of the pixel values of homogeneous pixels and the pixel value of the defective pixel. In addition, under a dark condition, the offset value may be a difference between the median value of the pixel values of homogeneous pixels of the defective pixel and a pixel value of the defective pixel. Alternatively, under a white condition, the offset value may be a difference between the median value of the pixel values of homogeneous pixels of the defective pixel and a pixel value of the defective pixel. Furthermore, the offset value may be a difference between the pixel value of the defective pixel and a pixel value of any one of the peripheral pixels under the dark condition or the white condition. A method of calculating the offset value is not limited to the above description, and various methods may also be used to represent a difference between the defective pixel and the peripheral pixels in order to calculate the offset value.

An offset value may exist for each of the defective pixels. For example, when the target pixel is a defective pixel, the offset value of the target pixel may be a value determined based on a pixel value of the target pixel and pixel values of first homogeneous pixels having the same color as the target pixel. In addition, the offset value of a cluster defective pixel may be a value determined based on a pixel value of the cluster defective pixel and pixel values of second homogeneous pixels having the same color as the cluster defective pixel within the kernel.

When the pixel value of the defective pixel is included in a predetermined range and the offset value corresponding to the defective pixel is included in another predetermined range, the offset correction determiner 230 may determine to correct defective pixels based on the offset value. More specific details regarding the method for determining whether to correct the defective pixels based on the offset value by the offset correction determiner 230 will be described later.

The defective pixel corrector 240 may receive, from the offset correction determiner 230, information (OI) on whether offset-based correction is performed, and may generate processed image data (PID) by correcting defective pixels based on the received information (OI). Specifically, the defective pixel corrector 240 may correct the target pixel and at least one cluster defective pixel based on a result of determining whether to perform correction by the offset correction determiner 230. For example, upon determining that the target pixel and at least one cluster defective pixel are to be corrected based on the offset value, the defective pixel corrector 240 may correct the target pixel value of the target pixel and the cluster defective pixel value of at least one cluster defective pixel by using a value that is obtained by subtracting a correction value calculated using both the offset value and parameter values for the offset value from a target pixel value of the target pixel. A more detailed description of the method for correcting the defective pixels by the defective pixel corrector 240 will be described later.

The memory 300 may store coordinates of defective pixels and offset values for the defective pixels. For example, the memory 300 may be a One-Time Programmable (OTP) memory, but is not limited thereto.

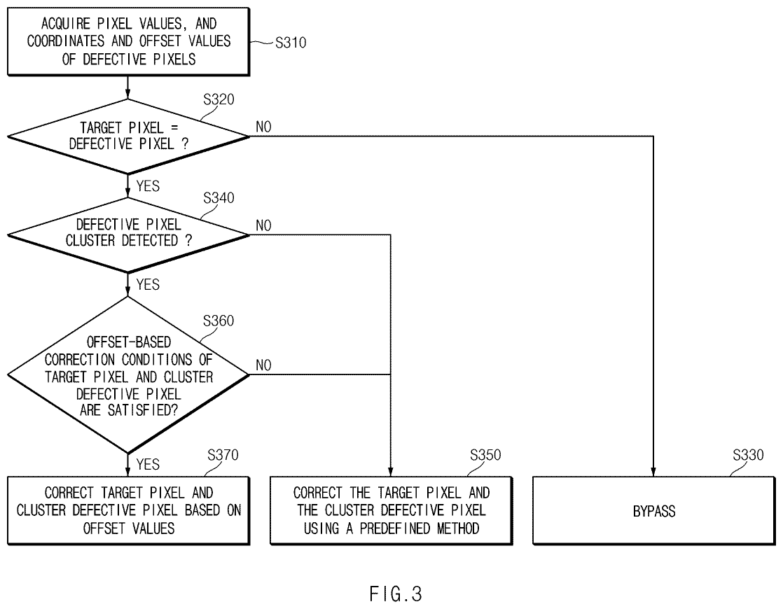

FIG. 3 is a flowchart illustrating an example of an image processing method according to embodiments of the present disclosure.

Referring to FIG. 3, the image processing method may acquire pixel values, coordinates of defective pixels, and offset values of the defective pixels (Operation S310). For example, the image processing device may acquire pixel values from the image sensing device, and may acquire the coordinates and offset values of the defective pixels from the memory.

The image processing method may determine whether the target pixel is a defective pixel (Operation S320). For example, the image processing method may include determining whether the target pixel is a defective pixel by comparing the coordinates of defective pixels acquired from the memory with the coordinates of the target pixel serving as the center pixel of the kernel.

When it is determined that the target pixel is not a defective pixel (Operation S320, NO), the image processing method may bypass the target pixel (Operation S330). Specifically, when the target pixel of the current kernel is not a defective pixel, the image processing method may move the position of the kernel to determine whether a new target pixel within a next kernel is a defective pixel.

When it is determined that the target pixel is a defective pixel (Operation S320, YES), the image processing method may detect a defective pixel cluster (Operation S340). In more detail, when the target pixel is a defective pixel, the image processing method may detect a cluster defective pixel that shares the floating diffusion node with the target pixel, and may determine whether a defective pixel cluster is included within the kernel. More specific details regarding such detection of the defective pixel cluster are described herein below.

When it is determined that the kernel does not include a defective pixel cluster, the image processing method may correct the target pixel and the cluster defective pixels using a predefined method (Operation S350). For example, the image processing method may correct the defective pixels using the average value or the median value of pixel values of homogeneous pixels having the same color as the defective pixel, but the scope of the method for correcting the defective pixels is not limited thereto.

When it is determined that the kernel includes a defective pixel cluster, the image processing method may determine whether offset-based correction conditions of the target pixel and the cluster defective pixel are satisfied (Operation S360). Specifically, when the pixel value of the target pixel is included in a predetermined range and the offset value is included in another predetermined range, the image processing method may determine to correct the target pixel and at least one cluster defective pixel based on the offset value. More specific details regarding such determination of whether to perform correction based on the offset value will be described later.

Upon determining that the defective pixels are not to be corrected based on the offset value (Operation S360, NO), the image processing method may correct the target pixel and the cluster defective pixel using a predefined method (Operation S350). For example, the image processing method may correct the defective pixels using the average value or the median value of pixel values of homogeneous pixels having the same color as the defective pixel, but the scope of the method for correcting the defective pixels is not limited thereto.

Upon determining that the defective pixels are to be corrected based on the offset value (Operation S360, YES), the image processing method may correct the target pixel and the cluster defective pixel based on the offset value (Operation S370). More specific details regarding such correction of the target pixel and the cluster defective pixels based on the offset value are described herein below.

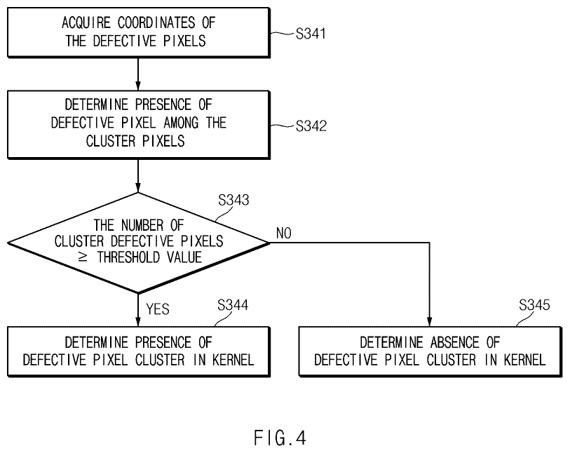

FIG. 4 is a flowchart illustrating an example of an image processing method according to embodiments of the present disclosure.

Hereinafter, the image processing method of FIG. 4 according to embodiments of the present disclosure will be described with reference to FIG. 3.

The operations of the image processing method shown in FIG. 4 may be operations that further specify the operation S340 of FIG. 3.

The image processing method according to an embodiment of the present disclosure may acquire coordinates of the defective pixels (Operation S341). For example, the image processing method may acquire the coordinates of defective pixels from the memory.

The image processing method may determine whether the cluster pixels include any defective pixels (Operation S342). Specifically, the image processing method may determine whether cluster defective pixels, which are defective pixels among the cluster pixels sharing the floating diffusion node with the target pixel, are present. For example, the image processing method may detect cluster defective pixels by comparing the acquired coordinates of defective pixels with the coordinates of the cluster pixels.

The image processing method may determine whether the number of cluster defective pixels is equal to or greater than a threshold value (Operation S343). For example, assuming that four pixels share a floating diffusion node, the image processing method may determine whether the number of cluster defective pixels is two or more. In other words, since the target pixel has already been determined to be a defective pixel, when there are two cluster defective pixels, the defective pixel cluster may be considered to include three defective pixels. Also, assuming that eight pixels share a floating diffusion node, the image processing method may determine whether the number of cluster defective pixels is 6 or more. In other words, since the target pixel has already been determined to be a defective pixel, when there are six cluster defective pixels, the defective pixel cluster may be considered to include 7 defective pixels. The above-described numerical values are merely examples for convenience of description, other implementations are also possible, and the scope of the image processing method according to an embodiment of the present disclosure is not limited thereto.

When it is determined that the number of cluster defective pixels is equal to or greater than a threshold value (Operation S343, YES), the image processing method may determine that the defective pixel cluster is included in the kernel (Operation S344). Referring to FIG. 3, when the image processing method determines that the kernel includes a defective pixel cluster, the image processing method proceeds to operation S360 to determine whether the offset-based correction conditions for the target pixel and the cluster defective pixels are satisfied.

When it is determined that the number of cluster defective pixels is less than the threshold value (Operation S343, NO), the image processing method may determine that the defective pixel cluster is not included in (i.e., absent from) the kernel (Operation S345). Referring to FIG. 3, when the image processing method determines that the defective pixel cluster is not included in the kernel, the image processing method proceeds to operation S350 to correct the target pixel and the cluster defective pixels using a predefined method.

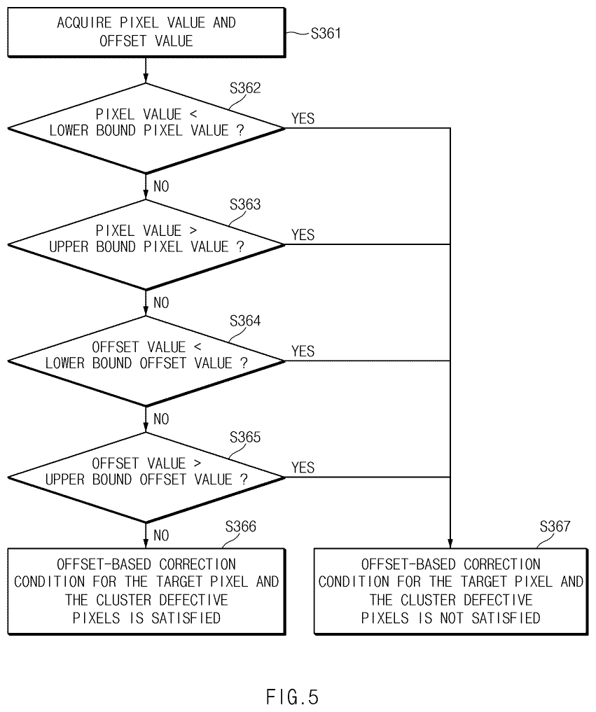

FIG. 5 is a flowchart illustrating an example of an image processing method according to embodiments of the present disclosure.

Hereinafter, the image processing method of FIG. 5 according to embodiments of the present disclosure will be described with reference to FIG. 3.

The operations of the image processing method shown in FIG. 5 may be operations that further specify the operation S360 of FIG. 3.

Referring to FIG. 5, the image processing method according to an embodiment of the present disclosure may acquire the pixel value and the offset value (Operation S361). Specifically, the image processing method may acquire pixel values from the image sensing device, and may acquire offset values for defective pixels from the memory.

When correcting defective pixels, the image processing method may correct all the defective pixels based on the offset value of the target pixel, or may correct each of the defective pixels based on an offset value of each of the defective pixels. For example, the image processing method may correct both the target pixel and at least one cluster defective pixel using a first offset value of the target pixel. In addition, the image processing method may correct the target pixel using the first offset value of the target pixel. Alternatively, the image processing method may correct the first cluster defective pixel using a second offset value of the first cluster defective pixel. Furthermore, when a second cluster defective pixel is included in the kernel, the second cluster defective pixel may be corrected using a third offset value of the second cluster defective pixel.

The image processing method may determine whether the pixel value of a defective pixel is less than a lower bound pixel value (operation S362). For example, assuming that defective pixels in the kernel are corrected using only the offset value of the target pixel, the image processing method may determine whether the target pixel value is less than the lower bound pixel value (also referred to as a third threshold pixel value).

In addition, assuming that the defective pixels are corrected using offset values thereof, the image processing method may determine whether each of pixel values of the defective pixels (i.e., the target pixel and at least one cluster defective pixel) is less than the lower bound pixel value (Operation S362). For example, assuming that a first cluster defective pixel and a second cluster defective pixel are included in the kernel, the image processing method may determine whether each of the pixel value of the target pixel, the pixel value of the first cluster detective pixel, and the pixel value of the second cluster defective pixel is less than the lower bound pixel value.

When it is determined that the pixel value of the defective pixel is less than the lower bound pixel value (Operation S362, YES), the image processing method may determine that the offset-based correction condition for the target pixel and the cluster defective pixels is not satisfied (Operation S367). Since the offset-based correction condition is not satisfied, the image processing method may correct the target pixel and the cluster defective pixels using a predefined method, as in operation S350 of FIG. 3.

Upon determining that the pixel value of the defective pixel is not less than the lower bound pixel value (Operation S362, NO), the image processing method may determine whether the pixel value of the defective pixel is greater than the upper bound pixel value (Operation S363). For example, assuming that all defective pixels in the kernel are corrected using only the offset value of the target pixel, the image processing method may determine whether the target pixel value is greater than the upper bound pixel value (also referred to as a fourth threshold pixel value).

Assuming that the defective pixels are corrected using offset values thereof, the image processing method may determine whether each of pixel values of the defective pixels (i.e., the target pixel and at least one cluster defective pixel) is greater than the upper bound pixel value (Operation S363). For example, assuming that a first cluster defective pixel and a second cluster defective pixel are included in the kernel, the image processing method may determine whether each of the pixel value of the target pixel, the pixel value of the first cluster detective pixel, and the pixel value of the second cluster defective pixel is greater than the upper bound pixel value.

When it is determined that the pixel value of the defective pixel is greater than the upper bound pixel value (Operation S363, YES), the image processing method may determine that the offset-based correction condition for the target pixel and the cluster defective pixels is not satisfied (Operation S367). Since the offset-based correction condition is not satisfied, the image processing method may correct the target pixel and the cluster defective pixels using a predefined method, as in operation S350 of FIG. 3.

Upon determining that the pixel value of the defective pixel is not greater than the upper bound pixel value (Operation S363, NO), the image processing method may determine whether the offset value of the defective pixel is less than the lower bound offset value (Operation S364). For example, assuming that defective pixels in the kernel are corrected using only the offset value of the target pixel, the image processing method may determine whether the first offset value of the target pixel is less than the lower bound offset value (also referred to as a first threshold offset value).

Assuming that the defective pixels are corrected using offset values thereof, the image processing method may determine whether each of offset values of the defective pixels (i.e., the target pixel and at least one cluster defective pixel) is less than the lower bound offset value (Operation S364). For example, assuming that a first cluster defective pixel and a second cluster defective pixel are included in the kernel, the image processing method may determine whether a first offset value of the target pixel is less than the lower bound offset value, may determine whether a second offset value of the first cluster defective pixel is less than the lower bound offset value, and may determine whether a third offset value of the second cluster defective pixel is less than the lower bound offset value.

When it is determined that the offset value of the defective pixel is less than the lower bound pixel value (Operation S364, YES), the image processing method may determine that the offset-based correction condition for the target pixel and the cluster defective pixels is not satisfied (Operation S367). Since the offset-based correction condition is not satisfied, the image processing method may correct the target pixel and the cluster defective pixels using a predefined method, as in operation S350 of FIG. 3.

Upon determining that the offset value of the defective pixel is not less than the lower bound pixel value (Operation S364, NO), the image processing method may determine whether the offset value of the defective pixel is greater than the upper bound offset value (Operation S365). For example, assuming that defective pixels in the kernel are corrected using only the offset value of the target pixel, the image processing method may determine whether the first offset value of the target pixel is greater than the upper bound offset value (also referred to as a second threshold offset value).

Assuming that the defective pixels are corrected using offset values thereof, the image processing method may determine whether each of offset values of the defective pixels (i.e., the target pixel and at least one cluster defective pixel) is greater than the upper bound offset value (Operation S365). For example, assuming that a first cluster defective pixel and a second cluster defective pixel are included in the kernel, the image processing method may determine whether a first offset value of the target pixel is greater than the upper bound offset value, may determine whether a second offset value of the first cluster defective pixel is greater than the upper bound offset value, and may determine whether a third offset value of the second cluster defective pixel is greater than the upper bound offset value.

When it is determined that the offset value of the defective pixel is greater than the upper bound pixel value (Operation S365, YES), the image processing method may determine that the offset-based correction condition for the target pixel and the cluster defective pixels is not satisfied (Operation S367). Since the offset-based correction condition is not satisfied, the image processing method may correct the target pixel and the cluster defective pixels using a predefined method, as in operation S350 of FIG. 3.

When it is determined that the offset value of the defective pixel is not greater than the upper bound offset value (Operation S365, NO), the image processing method may determine that the offset-based correction condition for the target pixel and the cluster defective pixels is not satisfied. Since the offset-based correction condition is satisfied (Operation S366), the image processing method may correct the target pixel and the cluster defective pixels using a predefined method, as in operation S370 of FIG. 3.

The order of operations S362 to S365 described above is merely an example, and the order of operations S362 to S365 may be changed or executed simultaneously.

The operations S361 to S367 described above may be expressed in pseudocode as follows:

$$valid 1 = ( pxl < reg\_shared \_pxl \_lower \_bound )$$

$$valid 2 = ( pxl > reg\_shared \_pxl \_upper \_bound )$$

$$valid 3 = ( offset < reg\_shared \_offset \_lower \_bound )$$

$$valid 4 = ( offset < reg\_shared \_offset \_upper \_bound )$$

$$fail\_pxl \_valid = ( valid 1 \vert valid 2 )$$

$$fail\_offset \_valid = ( valid 3 \vert valid 4 )$$

$$fail\_valid = ( fail\_pxl \_valid \vert fail\_offset \_valid )$$

Here, “pxl” may indicate the pixel value of the defective pixel, “offset” may indicate the offset value of the defective pixel, “reg_shared_pxl_lower_bound” may indicate the lower bound pixel value, “reg_shared_pxl_upper_bound” may indicate the upper bound pixel value, “reg_shared_offset_lower_bound” may indicate the lower bound offset value, and “reg_shared_offset_upper_bound” may indicate the upper bound offset value. “fail_valid” may indicate an example case where the pixel value and the offset value do not satisfy the offset-based correction condition. “fail_pxl_valid” may indicate a failure to meet the offset-based correction condition in relation to the pixel value, and “fail_offset_valid” may indicate an example case in which the offset-based correction condition is not satisfied in relation to the offset value. “valid1”, “valid2”, “valid3”, and “valid4” may correspond to S362, S353, S364, and S365, respectively. Therefore, if “fail_valid” is set to 1, it may be determined that the offset-based correction condition has not been satisfied, so that the target pixel and the cluster defective pixels can be corrected using a predefined method, as in operation S350 of FIG. 3. Conversely, if “fail_valid” is set to zero ‘0’, it may be determined that the offset-based correction condition has been satisfied, so that the target pixel and the cluster defective pixels can be corrected based on the offset value, as in operation S370 of FIG. 3.

The lower bound pixel value, the upper bound pixel value, the lower bound offset value, and the upper bound offset value may be user parameters, and may be determined according to user settings. The lower bound pixel value, the upper bound pixel value, the lower bound offset value, and the upper bound offset value may also be determined in association with characteristics of the image sensing device. For example, the lower bound pixel value and the lower bound offset value may be at a minimum of 0, and assuming that 10-bit data is used, each of the upper bound pixel value and the upper bound offset value may be at a maximum of 1023.

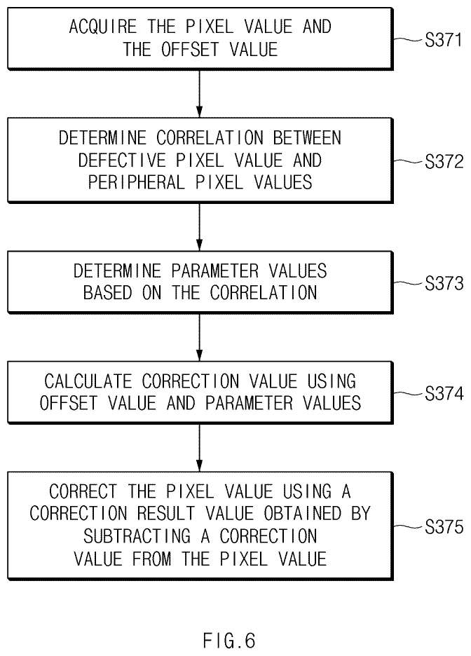

FIG. 6 is a flowchart illustrating an example of an image processing method according to embodiments of the present disclosure.

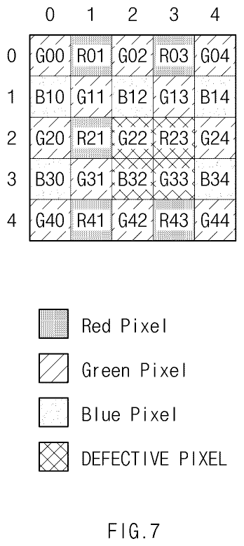

FIG. 7 is a schematic diagram illustrating an example of an image processing method according to embodiments of the present disclosure.

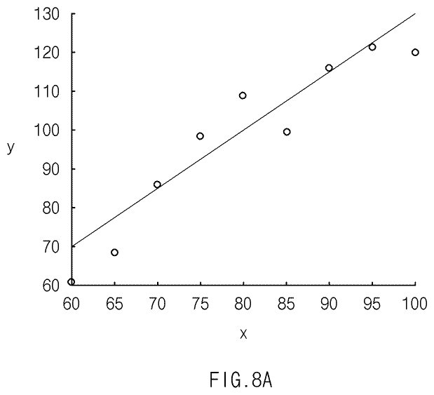

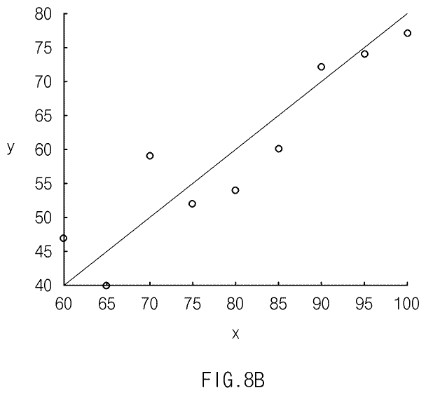

FIGS. 8A and 8B are schematic diagrams illustrating an example of an image processing method according to embodiments of the present disclosure.

Hereinafter, the image processing method of FIG. 6 according to embodiments of the present disclosure will be described with reference to FIGS. 3, 7 and 8A to 8B.

The operations of the image processing method shown in FIG. 6 may be operations that further specify the operation S370 of FIG. 3.

Referring to FIG. 6, the image processing method may acquire the pixel values and the offset values (Operation S371). For example, the image processing method may acquire pixel values from the image sensing device, and may acquire offset values from the memory.

The image processing method may determine a correlation between the defective pixel value and the peripheral pixel values (Operation S372). For example, as shown in FIG. 7, it may be assumed that a (5×5) kernel exists and a defective pixel cluster including four defective pixels is included in the kernel. When each of the pixels is represented by color and coordinates, the target pixel located at the center of the kernel may be denoted as G22, and the cluster defective pixels may be denoted as R23, B32, and G33, respectively. The image processing method may use the average or median value of the pixel values of the peripheral pixels to determine the correlation between the defective pixel values and the peripheral pixel values. For example, the image processing method may compare a target pixel value of the target pixel G22 with the average or median pixel value of the first homogeneous pixels (G00, G02, G04, G11, G13, G20, G24, G31, G40, G42, G44) serving as the peripheral pixels of the target pixel (G22). The image processing method may also compare a first cluster defective pixel value of the first cluster defective pixel (R23) with the average or median pixel value of the second homogeneous pixels (R01, R03, R21, R41, R43) of the first cluster defective pixel (R23). The image processing method may compare the second cluster defective pixel value of the second cluster defective pixel (B32) with the average or median pixel value of the third homogeneous pixels (B10, B12, B14, B30, B34) of the second cluster defective pixel (B32). In addition, the image processing method may compare a third cluster defective pixel value of the third cluster defective pixel (G33) with the average or median pixel value of the fourth homogeneous pixels (G00, G02, G04, G11, G13, G20, G24, G31, G40, G42, G44) of the third cluster defective pixel (G33).

When the pixel values of the homogeneous pixels corresponding to the target pixel and each of the cluster defective pixels are compared and plotted on a graph, the comparison result may be represented as shown in FIG. 8A or 8B. In FIGS. 8A and 8B, an X-axis may represent pixel values of the defective pixels, and a Y-axis may represent pixel values, average pixel values, or median pixel values of the peripheral pixels (i.e., the homogeneous pixels corresponding to each of the defective pixels). In other words, the correlation between the target pixel, the cluster defective pixels and the peripheral pixels may result in a linear relationship derived through linear regression, as illustrated in FIG. 8A or 8B. However, the correlation according to embodiments of the present disclosure is not limited thereto.

In operation S373, the image processing method may determine parameter values based on the correlation.

The image processing method may calculate the corrected pixel value as shown in Equation 1.

$$output = pxl - ( a \times {offset}^{2} + β \times offset + γ ) \qquad [ Equation 1 ]$$

In Equation 1, “output” may denote the corrected pixel value, “pxl” may represent the pixel value of the defective pixel, “offset” may represent the offset value of the defective pixel, and the parameters α, β, and γ may respectively denote parameter values associated with the offset value.

The image processing method may determine the values of α, β, and γ based on the identified correlation. For example, assuming that the linear correlation with a slope of 1 is derived as illustrated in FIG. 8A, the image processing method may determine “α=0” and “β=1”, and may also determine the value of “γ” to be a non-zero value. In another example, where the linear correlation with an arbitrary slope (not equal to 1) is derived as illustrated in FIG. 8B, the image processing method may determine “α=0”, and may determine each of β and γ to be a non-zero value.

The image processing method may calculate a correction value using the offset value and the parameter values (Operation S374). In this case, the correction value may be represented by the expression (αxoffset²+βxoffset+γ) as defined in Equation 1. Although Equation 1 expresses the corrected pixel value as the result of subtracting the correction value from the pixel value, the image processing method may alternatively calculate the corrected pixel value by adding the correction value to the pixel value.

The image processing method may correct the pixel values of the defective pixels by using only the offset value of the target pixel, or may correct the pixel values of the defective pixels by using offset values of the defective pixels. In other words, depending on the implementation of the image processing method, the parameter “offset” shown in Equation 1 may be fixed to the offset value of the target pixel, or may also be changed to the offset values of the respective defective pixels.

For example, in a case where the target pixel, a first cluster defective pixel, and a second cluster defective pixel are corrected using only a first offset value corresponding to the target pixel, the corrected pixel values may be as follows:

$$Corrected target pixel value = target pixel value = \{ a \times {( first offset value )}^{2} + β \times ( first offset value ) + γ \}$$

$$Corrected first cluster defective pixel value = first cluster defective pixel value - \{ a \times {( first offset value )}^{2} + β \times ( first offset value ) + γ \}$$

$$Corrected second cluster defective pixel value = second cluster defective pixel value - \{ a \times {( first offset value )}^{2} + β \times ( first offset value ) + γ \}$$

On the other hand, in a case where the pixel values of the defective pixels are corrected using the offset values of the defective pixels, the corrected pixel values may be as follows:

$$Corrected target pixel value = target pixel value = \{ a \times {( first offset value )}^{2} + β \times ( first offset value ) + γ \}$$

$$Corrected first cluster defective pixel value = first cluster defective pixel value - \{ a \times {( second offset value )}^{2} + β \times ( second offset value ) + γ \}$$

$$Corrected second cluster defective pixel value = second cluster defective pixel value - \{ a \times {( third offset value )}^{2} + β \times ( third offset value ) + γ \}$$

In operation S375, the image processing method may correct the pixel value of a defective pixel using a correction result value obtained by subtracting a correction value from the pixel value of the defective pixel. Specifically, the image processing method may correct the pixel value of the defective pixel using the output value calculated according to Equation 1, thereby improving the quality of the output image.

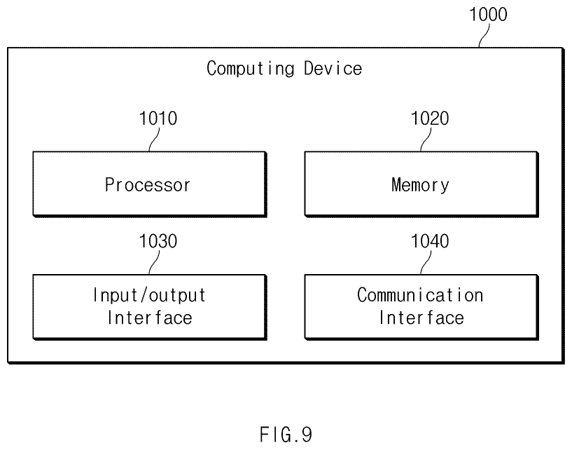

FIG. 9 is a block diagram illustrating an example of a computing device 1000 corresponding to the image processing device 200 of FIG. 1.

Referring to FIG. 9, the computing device 1000 may represent an embodiment of a hardware configuration for performing the operation of the image processing device 200 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the present disclosure is not limited thereto.

Additionally, the internal configuration or arrangement of the computing device 1000 and the image sensing device may vary depending on the embodiment. For example, at least a portion of the image sensing device may be included in the computing device 1000. Alternatively, at least a portion of the computing device 1000 may be included in the image sensing device. In this case, at least a portion of the computing device 1000 may be mounted together on a chip on which the image sensing device is mounted.

The computing device 1000 may include a processor 1010, a memory 1020, an input and output (input/output) (I/O) interface 1030, and a communication interface 1040.

The processor 1010 may process data and/or instructions required to perform the operations of the components of the image processing device 200 described in FIG. 1. That is, the processor 1010 may refer to the image processing device 200, but the scope of the present disclosure is not limited thereto.

The memory 1020 may store data and/or instructions required to perform operations of the components of the image processing device 200, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), Electrically Erasable PROM (EEPROM), flash memory, etc.).

That is, the computer program for performing the operations of the image processing device 200 disclosed in this document is recorded in the memory 1020 and executed and processed by the processor 1010, thereby implementing the operations of the image processing device 200.

The input/output (I/O) interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, external memory, etc.), and may be a device that supports wired or wireless communication.

As is apparent from the above description, the image processing device according to the embodiments of the present disclosure may correct pixel values of cluster defective pixels without erroneous correction (e.g., miscorrection or overcorrection).

The image processing device according to the embodiments of the present disclosure may detect cluster defective pixels using a memory in which coordinates of defective pixels are stored.

The embodiments of the present disclosure may provide a variety of effects capable of being directly or indirectly recognized through the above-mentioned disclosure.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. An image processing device comprising:
a target pixel defect determiner configured to determine whether a target pixel within a kernel is a defective pixel;
a cluster defective pixel detector configured to detect at least one cluster defective pixel that serves as the defective pixel sharing a floating diffusion node with the target pixel, when the target pixel is determined to be the defective pixel;
an offset correction determiner configured to determine whether to correct the target pixel and the at least one cluster defective pixel based on an offset value of the target pixel; and
a defective pixel corrector configured to correct the target pixel and the at least one cluster defective pixel based on a determination to correct the target pixel and the at least one cluster defective pixel.

2. The image processing device according to claim 1, wherein the offset correction determiner is configured to:
determine whether to correct the target pixel and the at least one cluster defective pixel when a number of the at least one cluster defective pixel is greater than or equal to a threshold value.

3. The image processing device according to claim 1, wherein:
the offset value is determined based on a target pixel value of the target pixel and first homogeneous pixel values of first homogeneous pixels having a same color as the target pixel within the kernel.

4. The image processing device according to claim 3, wherein:
the offset value is a difference between an average value of the first homogeneous pixel values and the target pixel value, under a dark condition in which the target pixel value is less than a first threshold pixel value or under a white condition in which the target pixel value is greater than a second threshold pixel value.

5. The image processing device according to claim 3, wherein:
the offset value is a difference between a median value of the first homogeneous pixel values and the target pixel value, under a dark condition in which the target pixel value is less than a first threshold pixel value or under a white condition in which the target pixel value is greater than a second threshold pixel value.

6. The image processing device according to claim 1, wherein the offset correction determiner is configured to:
determine that the target pixel and the at least one cluster defective pixel are to be corrected based on the offset value, when a target pixel value of the target pixel is greater than a third threshold pixel value and less than a fourth threshold pixel value, and the offset value is greater than a first threshold offset value and less than a second threshold offset value.

7. The image processing device according to claim 1, wherein the defective pixel corrector is configured to:
in response to determining that the target pixel and the at least one cluster defective pixel are to be corrected based on the offset value, correct a target pixel value of the target pixel and a cluster defective pixel value of the at least one cluster defective pixel based on a value that is obtained by subtracting a correction value calculated using both the offset value and parameter values for the offset value from a target pixel value of the target pixel.

8. The image processing device according to claim 7, wherein the defective pixel corrector is configured to:
determine the parameter values based on a correlation among first homogeneous pixel values of first homogeneous pixels having a same color as the target pixel within the kernel, the target pixel value of the target pixel, second homogeneous pixel values of second homogeneous pixels having a same color as the at least one cluster defective pixel, and cluster defective pixel values of the at least one cluster defective pixel.

9. The image processing device according to claim 1, wherein the offset correction determiner is configured to:
when it is not determined that the target pixel and the at least one cluster defective pixel are to be corrected based on the offset value, correct the target pixel and the at least one cluster defective pixel based on an average value or a median value of first homogeneous pixel values of first homogeneous pixels having a same color as the target pixel within the kernel.

10. The image processing device according to claim 9, wherein the cluster defective pixel detector is configured to:
detect the at least one cluster defective pixel based on coordinates of the defective pixel stored in an external memory.

11. The image processing device according to claim 10, wherein:
the external memory is a one-time programmable (OTP) memory.

12. An image processing device comprising:
a target pixel defect determiner configured to determine whether a target pixel within a kernel is a defective pixel;
a cluster defective pixel detector configured to detect a cluster defective pixel that serves as the defective pixel sharing a floating diffusion node with the target pixel, when the target pixel is determined to be the defective pixel;
an offset correction determiner configured to determine whether to correct the target pixel based on a first offset value of the target pixel and to correct the cluster defective pixel based on a second offset value of the cluster defective pixel; and
a defective pixel corrector configured to correct the target pixel and the cluster defective pixel based on a determination to correct the target pixel and the cluster defective pixel.

13. The image processing device according to claim 12, wherein:
the first offset value is determined based on a target pixel value of the target pixel and first homogeneous pixel values of first homogeneous pixels having a same color as the target pixel within the kernel; and
the second offset value is determined based on a cluster defective pixel value of the cluster defective pixel and second homogeneous pixel values of second homogeneous pixels having a same color as the cluster defective pixel within the kernel.

14. The image processing device according to claim 13, wherein:
the first offset value is a difference between an average value of the first homogeneous pixel values and the target pixel value under a first dark condition in which the target pixel value is less than a first threshold pixel value, or under a first white condition in which the target pixel value is greater than a second threshold pixel value; and
the second offset value is a difference between an average value of the second homogeneous pixel values and the cluster defective pixel value under a second dark condition in which the cluster defective pixel value is less than the first threshold pixel value, or under a second white condition in which the cluster defective pixel value is greater than the second threshold pixel value.

15. The image processing device according to claim 13, wherein:
the first offset value is a difference between a median value of the first homogeneous pixel values and the target pixel value under a first dark condition in which the target pixel value is less than a first threshold pixel value, or under a first white condition in which the target pixel value is greater than a second threshold pixel value; and
the second offset value is a difference between a median value of the second homogeneous pixel values and the cluster defective pixel value under a second dark condition in which the cluster defective pixel value is less than the first threshold pixel value, or under a second white condition in which the cluster defective pixel value is greater than the second threshold pixel value.

16. The image processing device according to claim 12, wherein the offset correction determiner is configured to:
in response to determining that a target pixel value of the target pixel and a cluster defective pixel value of the cluster defective pixel are greater than a third threshold pixel value and less than a fourth threshold pixel value, and the first offset value and the second offset value are greater than a first threshold offset value and less than a second threshold offset value, determine that the target pixel is to be corrected based on the first offset value, and the cluster defective pixel is to be corrected based on the second offset value.

17. The image processing device according to claim 12, wherein the defective pixel corrector is configured to:
in response to determining that the target pixel is to be corrected based on the first offset value, and the cluster defective pixel is to be corrected based on the second offset value,
correct the target pixel value using a first value obtained by subtracting a first correction value calculated using the first offset value and parameter values from a target pixel value of the target pixel; and
correct the cluster defective pixel value using a second value obtained by subtracting a second correction value calculated using the second offset value and the parameter values from a cluster defective pixel value of the cluster defective pixel.

18. The image processing device according to claim 17, wherein the defective pixel corrector is configured to:
determine the parameter values based on a correlation among first homogeneous pixel values of first homogeneous pixels having a same color as the target pixel within the kernel, second homogeneous pixel values of second homogeneous pixels having a same color as the cluster defective pixel, the target pixel value of the target pixel, and the cluster defective pixel value of the cluster defective pixel.

19. The image processing device according to claim 12, wherein the cluster defective pixel detector is configured to:
detect the cluster defective pixel based on coordinates of the defective pixel stored in an external memory.

20. An image processing device comprising:
a target pixel defect determiner configured to determine whether a target pixel within a kernel is a defective pixel;
a cluster defective pixel detector configured to determine whether at least some of cluster pixels sharing a floating diffusion node with the target pixel are defective pixels;
an offset correction determiner configured to determine whether to correct the target pixel and cluster defective pixels corresponding to the defective pixel among the cluster pixels based on offset values for the target pixel and the cluster defective pixels; and
a defective pixel corrector configured to correct the target pixel and the cluster defective pixels based on a determination to correct the target pixel and the cluster defective pixels.
